(19) United States
(12) Patent Application Publication
(10) Pub. No.: US 2004/0037741 A1
(43) Pub. Date: Feb. 26, 2004

(54) Predicting behaviour of a moulded composite component

(76) Inventor: Herve Barrellon, Chippenham (GB)

Correspondence Address: NIXON & VANDERHYE, PC, 1100 N GLEBE ROAD, 8TH FLOOR, ARLINGTON, VA, 22201-4714, US

(21) Appl. No.: 10/380,987

(22) PCT Filed: Sep. 21, 2001
(86) PCT No.: PCT/GB01/04205

(30) Foreign Application Priority Data
Oct. 3, 2000 (GB) 0024121.6

(51) Int. Cl. G01N 31/00

(52) U.S. Cl. 422/68.1; 436/1

(57) ABSTRACT

The predicting of behavious such as spring back of a moulded composite component (22) made from fibre and resin materials (13, 14) comprises, determining the temperature at which the resin (14) passes from a liquid state to a solid state, constructing a finite element model, producing from the fibre and resin a plurality of elements E1 to En smaller than the required component (22) determining for each element E1 to En at different temperatures the difference between variation in size caused thermally and variation in size caused chemically, taking the information obtained and adjusting the finite element model in response thereto, to enable a coefficient of thermal expansion to be determined, and using the finite element model (26) to provide an indication of the behaviour of the cured moulded composite component (21) on being removed from a mould (28).

The invention relates to a method of predicting material behaviour and is primarily concerned with the prediction of a phenomenon known as “spring back” in a moulded fibre/resin composite component.

Spring back is an angular distortion of a composite component relative to its mould once it has cured. For example, in the case of a moulded L-shaped component, the limbs of the component which are moulded at 90° tend to move (spring beck) relative to each other when the cured component is removed from the mould. It has been found that the spring back is primarily due to a difference in chemical and thermal properties of the fibre compared to that of the resin during curing of the composite.

Where a composite component is thin and fairly flexible, for example in a fairing for use on an aircraft, the problem of spring back can be overcome simply by bending the component slightly into the correct shape during installation. However, where a structural component is involved the problem of spring back becomes more acute as the size and thickness of the moulded component will normally make such bending impossible. Therefore, far more accuracy is required in making the moulding such that once it is cured, spring back will take the component to its correct shape. Where such accuracy is involved, the standard approach is a trial and error method. Depending on the accuracy required, the value of angular distortion on leaving the mould will be estimated and the component will be moulded accordingly. If, on leaving the mould, the component is not within manufacturing tolerances, the mould will be adjusted or even rebuilt and another component moulded. It will be appreciated that for very large components, for example, a large structural component for an aircraft, such a trial and error method is costly and inefficient.

An object of the present invention is to provide a method of predicting behaviour of a moulded composite component which will enable spring back to be predicted accurately without the inefficiency of the trial and error method currently used.

According to one aspect of the invention there is provided a method of predicting behaviour such as spring back of a moulded composite component made from fibre and resin materials, the method comprising determining the temperature at which the resin passes from a liquid state to a solid state, constructing a finite element model, producing from a fibre and resin corresponding to those from which the component is made a plurality of elements smaller than the component, determining for each element at different temperatures the difference between variation in size caused thermally and variation in size caused chemically, taking the information obtained and adjusting the finite element model in response thereto to enable a coefficient of thermal expansion to be determined, and using the finite element model to provide an indication of the behaviour of cured moulded composite components on being removed from the mould.

Preferably, the elements are miniature versions of at least a part of the component and for the most reliable results should be precise miniature versions. Each element may be identical to the other.

The method preferably involves producing from ten to fifteen of the said elements to enable data derived therefrom to be averaged to provide optimum accuracy. Preferably, said elements are produced in groups of three identical elements to provide statistical repeatability. For each group, the geometry of the corner (e.g. thickness, corner radius, lay up) may be varied.

According to a second aspect of the invention there is provided apparatus for performing the method of the first aspect of the invention or any of the subsidiary clauses relating thereto comprising cure monitoring means for determining the temperature at which the resin passes from a liquid state to a solid state, a plurality of elements smaller than the component to be moulded, the elements being made from fibre and resin materials corresponding to those from which the component is made, means for determining for each element at different temperatures the difference between variation in size caused thermally and variation in size caused chemically to enable the coefficient of thermal expansion to be determined, and a finite element model to which the determined parameters can be applied to provide an indication of the behaviour of the cured moulded composite on being removed from the mould.

The cure monitoring means is preferably a dielectric cure monitoring system. Such a system is of a kind which can be used to monitor chemical reaction in the resin during curing.

The finite element model is preferably a three dimensional model which preferably models discreet plies of fibre used to form the component, that is a three dimensional ply by ply finite element model.

A method and apparatus in accordance with the invention will now be described by way of example with reference the accompanying drawings in which:—

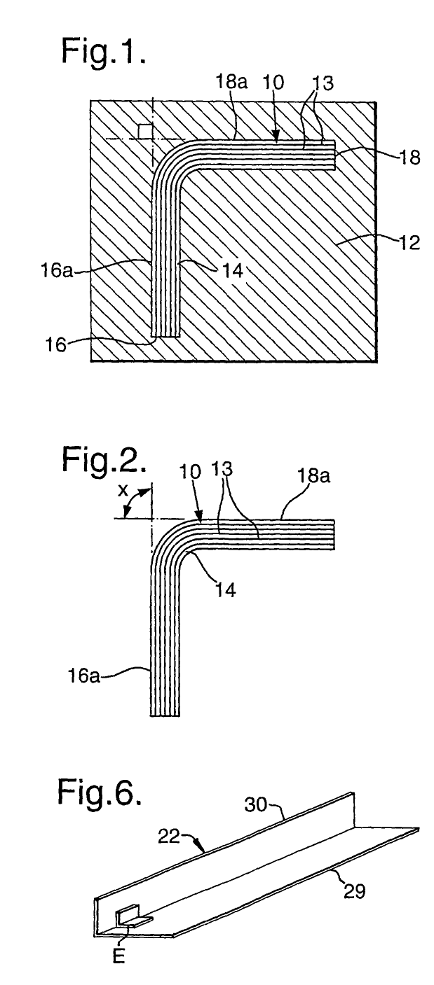

FIG. 1 shows a cross section of moulded composite component in a mould,

FIG. 2 shows the component removed from the mould and illustrates is the effect of spring back,

FIG. 3 shows steps in a method in accordance with the invention for predicting spring back in a moulded component,

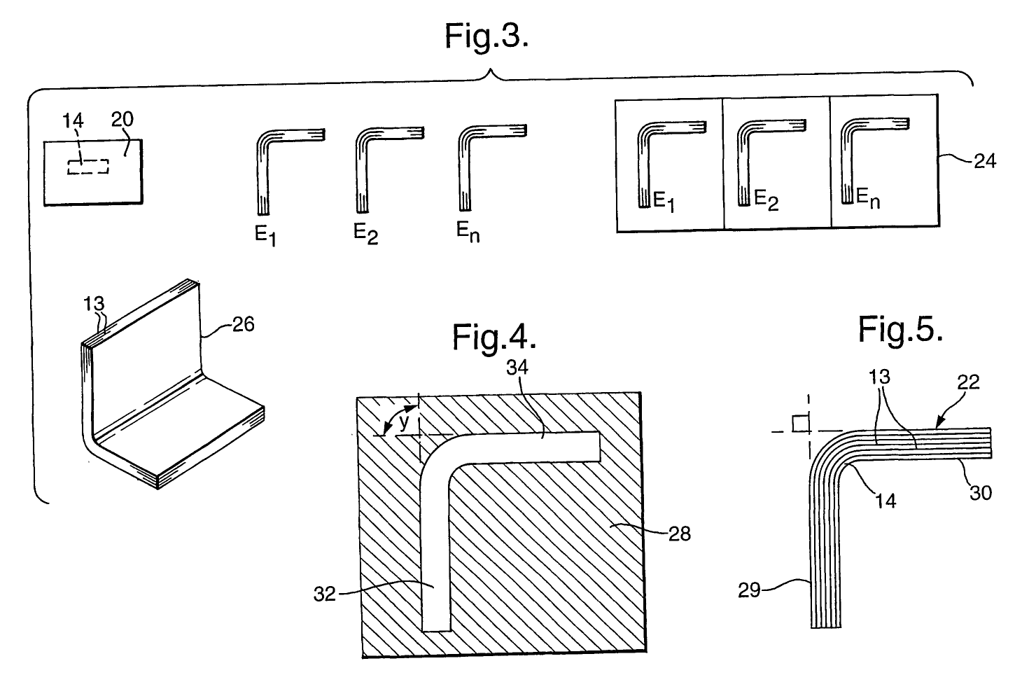

FIG. 4 shows a mould for use in forming the component using the method of FIG. 3 and

FIG. 5 shows a cross section of the component made in the mould of FIG. 4.

FIG. 6 shows the size of an element (E) to be produced from the component of FIGS. 2 and 5.

Looking at FIG. 1, an L-shaped component 10 is formed in a mould 12 as a composite using a lay up of carbon fibre plies 13 impregnated with resin 14. The mould 12 is made such that respective limbs 16, 18 of the component 10 have external surfaces 16a, 18a at right angles to each other.

The resin 14 is allowed to cure in the mould 12 and the component 10 is then removed as shown in FIG. 2. The curing of the resin 14 coupled with other properties, in particular the orientation of the plies 13, contribute to spring back of the limbs 16, 18 which, as shown in FIG. 2 results in the surfaces 16a, 18a no longer being at right angles but at a larger angle x relative to each other.

The present invention is aimed at predicting spring back in a moulded composite component.

Looking at FIG. 3, the method involves taking a sample of the type of resin 14 used in the composite, for example Hexcel 8552-AS4, and using a dielectric cure monitoring system 20 to determine what is known as the “stress free temperature”, that is the temperature at which the resin 14 passes from a liquid state to a solid state or gel point. Such a cure monitoring system 20 is of a known kind which can be used to monitor chemical reaction in the resin during curing and to determine the chemical shrinkage.

The data obtained is then used to construct a three dimensional ply by ply finite element model.

A number of composite elements E1, E2 . . . En are produced. In a preferred embodiment, between ten and fifteen of such elements will be produced. Each composite element E1 to En is an accurately formed miniature version of the component (indicated at 22 in FIG. 6) in which spring back is to be predicted. The component 22, like the component 10 in FIG. 1 is made up of carbon fibre plies 13 impregnated with resin 14. Each of the elements E1 to En is measured accurately at different temperatures at a measurement station 24 in order to determine thermal shrinkage separately for each component. The measurements taken from the elements E1 to En manufactured initially are used to calibrate the three dimensional ply by ply finite element model 26, i.e. the model is made to match the data obtained, thereby enabling the “true” coefficient of thermal expansion to be determined for the elements. The advantage of using ten to fifteen elements is that the data required can be deduced very accurately.

The finite element model 26 is a computer generated three dimensional model which has been set up to model the shape of the component 22 in which spring back is to be predicted and which models each discreet ply 13 of the component 22 and the particular orientation thereof. The measurements based on the elements E1 to En enable the finite model to be controlled whereby a complementary shaped mould 28 (see FIG. 4) can be constructed to produce the final component 22 in such a way that on removal of the component from the mould 28, the spring back in the component 22 will position limbs 29, 30 thereof precisely as required in the cured component. For example, in the mould 28 shown, sections 32, 34 thereof which mould the respective limbs 29, 30 are set at an angle y less than 90° so that the when the moulded component 22 springs back on removal from the mould, the limbs 28, 30 will lie at right angles to each other. When moulding a subsequent and different L-shaped component, data derived from measuring a miniature set of elements based on the subsequent component and the ply orientation thereof can be used as inputs to the calibrated finite element model 26 to predict the spring back and enable the mould to be shaped accordingly so as to compensate for spring back in the final cured component.

1 A method of predicting behaviour such as spring back of a moulded composite component (22) made from fibre and resin materials (13, 14), the method comprising determining the temperature at which the resin (14) passes from a liquid state to a solid state, constructing a finite element model (26), producing from a fibre and resin corresponding to those from which the component is made a plurality of elements (E₁ to Eₙ) smaller than the component, determining for each element (E₁ to Eₙ) at different temperatures the difference between variation in size caused thermally and variation in size caused chemically, taking the information obtained and adjusting the finite element model (26) in response thereto to enable a coefficient of thermal expansion to be determined, and using the finite element model (26) to provide an indication of the behaviour of the cured moulded composite component (22) on being removed from the mould (28).

2 A method according to claim 1 comprising forming the elements (E₁ to Eₙ) as miniature versions of the component.

3. A method according to claim 1 or 2 comprising forming the elements (E₁ to Eₙ) so as to be identical to each other.

4 A method according to 1, 2 or 3 comprising producing from ten to fifteen of the said elements (E₁ to Eₙ) to enable data derived therefrom to provide optimum accuracy.

5 Apparatus for performing a method of predicting behaviour such as spring back of a moulded composite component (22) made from fibre and resin materials (13, 14), the apparatus comprising cure monitoring means for determining the temperature at which the resin passes from a liquid state to a solid state, a plurality of elements (E₁ to Eₙ) smaller than the component to be moulded, the elements being made from fibre and resin materials corresponding to those from which the component is made, means for determining for each element at different temperatures the difference between variation in size caused thermally and variation in size caused chemically to enable the coefficient of thermal expansion to be determined, and a finite element model (26) to which the determined parameters can be applied to provide an indication of the behaviour of the cured moulded composite (22) on being removed from the mould (28).

6 Apparatus according to claim 5 in which the cure monitoring means is a dielectric cure monitoring system.

7 Apparatus according to claim 5 or 6 in which the finite element model is a three dimensional model.

8 Apparatus according to claim 5, 6 or 7 in which the finite element model models discreet plies from which the component is made.
